(19) United States
(12) Patent Application Publication
(10) Pub. No.: US 2025/0379268 A1
(43) Pub. Date: Dec. 11, 2025

(54) Metal-Carbon Dioxide Battery With Electrolyte Regeneration System

(71) Applicants: HYUNDAI MOTOR COMPANY, Seoul (KR); KIA CORPORATION, Seoul (KR); UIF (University Industry Foundation), Seoul (KR)

(72) Inventors: Se Won Pyo, Hwaseong-si (KR); Ji Hoon Jang, Hwaseong-si (KR); Shin Tae Bae, Hwaseong-si (KR); Yun Su Lee, Hwaseong-si (KR); Dong Il Lee, Goyang-si (KR); Dong Yoon Lee, Seoul (KR); Seung Hwan Kim, Seoul (KR)

(73) Assignees: HYUNDAI MOTOR COMPANY, Seoul (KR); KIA CORPORATION, Seoul (KR); UIF (University Industry Foundation), Seoul (KR)

(21) Appl. No.: 18/933,058

(22) Filed: Oct. 31, 2024

(30) Foreign Application Priority Data
Jun. 11, 2024 (KR) 10-2024-0075855

(51) Int. Cl. H01M 10/42; H01M 10/26; H01M 12/08

(52) U.S. Cl. CPC H01M 10/4242; H01M 10/26; H01M 12/08; H01M 2300/0014

(57) ABSTRACT

A metal-carbon dioxide battery with an electrolyte regeneration system, in which battery performance and durability can be improved by providing the electrolyte regeneration system to an anode side of the metal-carbon dioxide battery.

### CROSS-REFERENCE TO RELATED APPLICATION

This application claims, under 35 U.S.C. § 119(a), the benefit of priority from Korean Patent Application No. 10-2024-0075855, filed on Jun. 11, 2024, the entire contents of which are incorporated herein by reference.

### BACKGROUND

### (a) Technical Field

The present disclosure relates to a metal-carbon dioxide battery with an electrolyte regeneration system, in which battery performance and durability may be improved by providing the electrolyte regeneration system to an anode side of the metal-carbon dioxide battery.

### (b) Background

Recently, thorough research into electrochemical water electrolysis has been carried out in line with the development of renewable energy to respond to climate change. Also, the importance of carbon dioxide (CO₂) capture, storage, and conversion techniques for greenhouse gas reduction is growing.

Zinc/aluminum (Zn/Al)-based aqueous battery systems are very economical metal anode candidates in view of price and reserves. A zinc/aluminum (Zn/Al)-based aqueous battery system is capable of producing hydrogen and simultaneously capturing carbon dioxide in the form of carbonate such as KHCO₃, etc.

Conventional aqueous battery systems have the problem of limitations in battery performance and long-term operation as bicarbonate ions or carbonate ions remain in the anode electrolyte even after carbon dioxide is captured in the form of carbonate.

### SUMMARY OF THE DISCLOSURE

The disclosure addresses certain problems encountered in the related art, and provides an improved battery comprising an electrolyte regeneration system configured to remove bicarbonate ions and/or carbonate ions from an electrolyte.

The objects of the present disclosure are not limited to the foregoing. The objects of the present disclosure will be able to be clearly understood through the following various aspects and embodiments provided by the description, illustrative examples and drawings, and the claims and various combinations thereof.

An aspect of the present disclosure provides a metal-carbon dioxide battery, including a reaction unit including an anode, a cathode, and an ion exchange membrane located between the anode and the cathode, a first electrolyte supply unit configured to supply a first electrolyte including an alkali metal hydroxide to the anode, and a second electrolyte supply unit configured to supply a second electrolyte to the cathode, in which the first electrolyte is regenerated by precipitating carbonic anions in the form of carbonate by the first electrolyte supply unit.

In one embodiment, the concentration of the alkali metal hydroxide in the first electrolyte may be 1 M to 7 M.

In one embodiment, the pH of the first electrolyte may be pH 14 or higher.

In one embodiment, the alkali metal hydroxide may include any one selected from the group consisting of sodium hydroxide, potassium hydroxide, lithium hydroxide, and combinations thereof.

In one embodiment, the first metal M1 of a first metal oxide may include zinc (Zn), aluminum (Al), and combinations thereof.

In one embodiment, the metal-carbon dioxide battery may further include an oxide precipitation unit located downstream of the anode and configured to separate and recover the first metal oxide.

The oxide precipitation unit may include a first storage tank configured to accommodate a first product discharged from the anode and a first feeder configured to supply carbon dioxide to the first storage tank, in which the first metal oxide (M1Oₓ) may be precipitated from the first product by lowering the pH of the first product as carbon dioxide is supplied to the first storage tank.

As such, the first feeder may be configured to supply carbon dioxide to the first storage tank so that the pH of the first product is pH 10 to pH 12.

In one embodiment, the oxide precipitation unit may further include a first filter located downstream of the first storage tank and configured to separate the precipitated first metal oxide (M1Oₓ) from the first product.

In one embodiment, the first electrolyte supply unit may include a second storage tank configured to accommodate a second product including carbonic anions and a second feeder configured to supply a second metal hydroxide to the second storage tank, in which a second metal carbonate (M2CO₃) may be precipitated by reaction of the second product and the second metal hydroxide.

In one embodiment, the first electrolyte supply unit may further include a second filter configured to separate the precipitated second metal carbonate (M2CO₃) from the second product.

Also, the first electrolyte supply unit may further include a fourth storage tank located downstream of the second filter and configured to accommodate the first electrolyte filtered through the second filter and an electrolyte replenisher connected to the fourth storage tank and configured to replenish the fourth storage tank with an alkali metal hydroxide.

In one embodiment, the second metal M2 of the second metal hydroxide may include any one selected from the group consisting of calcium (Ca), strontium (Sr), barium (Ba), iron (Fe), lead (Pb), lithium (Li), copper (Cu), and combinations thereof.

In one embodiment, the molar ratio of an alkali metal carbonate in the second product to the second metal hydroxide supplied by the second feeder may be 1:1 to 1:3.

In one embodiment, precipitation reaction of the second metal carbonate may occur at a temperature of 80° C. or less.

According to an embodiment of the present disclosure, the ion exchange membrane may include an anion exchange membrane, and the anion exchange membrane may be configured to transfer carbonic anions, which are contained in the second electrolyte supplied to the cathode, to the anode.

In one embodiment, the anion exchange membrane may include any one selected from the group consisting of poly(terphenylene), 1,4-diazabicyclo[2,2,2]octane-poly(ether sulfone), poly(aryl piperidinium), poly(phenylene oxide)-block-poly(vinyl benzyl trimethyl ammonium), and combinations thereof.

According to another embodiment of the present disclosure, the ion exchange membrane may include a cation exchange membrane, and the cation exchange membrane may be configured to transfer the alkali metal ions contained in the first electrolyte to the cathode.

In one embodiment, the metal-carbon dioxide battery may further include a separation unit located at a cathode side and configured to separate hydrogen gas from the third product discharged from the cathode.

As such, the separation unit may include a gas-liquid separator.

In one embodiment, the separation unit may be connected to the second electrolyte supply unit, and an unreacted material discharged from the separation unit may be supplied to the second electrolyte supply unit.

In one embodiment, the second electrolyte supply unit may include a third storage tank configured to accommodate the second electrolyte and a third feeder connected to the third storage tank and configured to supply carbon dioxide to the third storage tank, in which a second electrolyte including carbonic anions may be formed by reaction of water and carbon dioxide in the third storage tank.

Also, the second electrolyte supply unit may further include a third filter located downstream of the third storage tank and configured to separate an alkali metal bicarbonate from the second electrolyte discharged from the third storage tank.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 schematically shows a metal-carbon dioxide battery according to the present disclosure;

FIG. 2 shows a metal-carbon dioxide battery according to an embodiment of the present disclosure;

FIG. 3 shows a metal-carbon dioxide battery according to another embodiment of the present disclosure;

FIG. 4 shows results of hydrochloric acid titration of the electrolyte after passing through the second filter during operation of a metal-carbon dioxide battery according to Example;

FIG. 5 shows results of hydrochloric acid titration of the electrolyte after passing through the second filter during operation of a metal-carbon dioxide battery according to Comparative Example;

FIG. 6 shows results of comparing the electrochemical performance of the metal-carbon dioxide battery according to Example during first operation and the performance thereof after the electrolyte regeneration process;

FIG. 7 shows results of comparing changes in battery performance over time during operation of the metal-carbon dioxide battery according to Example and the metal-carbon dioxide battery according to Comparative Example; and

FIG. 8 shows results of comparing XRD peaks of the solid salt recovered through the second filter and the known calcium carbonate.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

As used herein, the term “storage tank” may refer to a predetermined space provided for storing a fluid, with inlets and outlets formed to allow fluid to flow in and out of the predetermined space.

As used herein, the term ‘feeder’ may mean a configuration for providing a fluid, such as a liquid or gas, to the storage tank, and a configuration for flowing the fluid from the feeder to the storage tank through a pump or the like. In this case, the feeder and the storage tank may be connected by conduits, pipes, etc. even if no special mention is made thereof.

As used herein, the term “filter” refers to a device for filtering out precipitates in a liquid or gas, and may be used without limitation as long as it is capable of separating carbonates, metal oxides, bicarbonates, and the like. For example, gravity filters, vacuum filters, pressure filters, compression filters, electrostatic filters, nonwoven filters, fabric filters, and the like may be applied.

As used herein, when one configuration is said to be “connected” to another configuration, it may mean that the configurations are connected by a conduit or pipe so that fluid (liquid and/or gas) can flow from one configuration to the other, unless otherwise described.

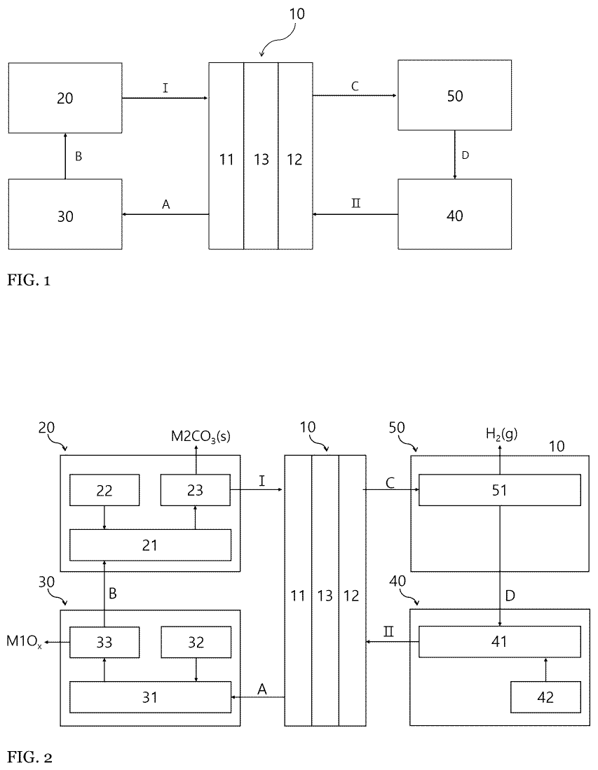

FIG. 1 schematically shows a metal-carbon dioxide battery according to the present disclosure. Referring to FIG. 1, the metal-carbon dioxide battery according to the present disclosure may include a reaction unit 10 including an anode 11, a cathode 12, and an ion exchange membrane 13 located between the anode 11 and the cathode 12, a first electrolyte supply unit 20 configured to supply a first electrolyte I including an alkali metal hydroxide (M3(OH)) to the anode 11, and a second electrolyte supply unit 40 configured to supply a second electrode II to the cathode 12.

The cathode 12 may include any one selected from the group consisting of carbon paper, carbon fiber, carbon felt, carbon cloth, metal foam, metal thin film, metal mesh, metal plate, and combinations thereof. The cathode 12 may further include an active metal supported on carbon paper, etc. The active metal is not particularly limited and may include a noble metal such as platinum (Pt), etc., and/or a transition metal such as nickel (Ni), molybdenum (Mo), etc. The cathode 12 may include any one selected from the group consisting of a noble metal catalyst such as platinum, a carbon-based catalyst, a carbon-metal-based catalyst, and combinations thereof, with high electrochemical activity of hydrogen generation reaction in order to promote hydrogen generation reaction.

The anode 11 may include a first metal M1. The first metal M1 may include zinc (Zn), aluminum (Al), and combinations thereof. Here, the combination of zinc and aluminum may mean that individual elements are present alone or in an alloy.

The ion exchange membrane 13 according to the present disclosure may include an anion exchange membrane (AEM) that blocks the movement of the electrolyte but allows anions to pass therethrough, or a cation exchange membrane (CEM) that blocks the movement of the electrolyte but allows cations to pass therethrough.

The carbonic anions, which are contained in the second electrolyte supplied to the cathode 12, may be transferred to the anode 11 by the anion exchange membrane 13. For reference, as used herein, the term “carbonic anions” may be understood to include carbonate ions (CO₃²⁻) and/or bicarbonate ions (HCO₃⁻).

The type of anion exchange membrane 13 is not particularly limited so long as it is used as the anion exchange membrane 13 in the relevant technical field, and may include, for example, any one selected from the group consisting of poly(terphenylene), 1,4-diazabicyclo[2,2,2]octane-poly(ether sulfone), poly(aryl piperidinium), poly(phenylene oxide)-block-poly(vinyl benzyl trimethyl ammonium), and combinations thereof.

The alkali metal M3 ions contained in the first electrolyte may be transferred to the cathode 12 by the cation exchange membrane 13.

The type of cation exchange membrane 13 is not particularly limited so long as it is used as the cation exchange membrane 13 in the relevant technical field, and may include, for example, a perfluorosulfonic acid-based resin such as Nafion, etc.

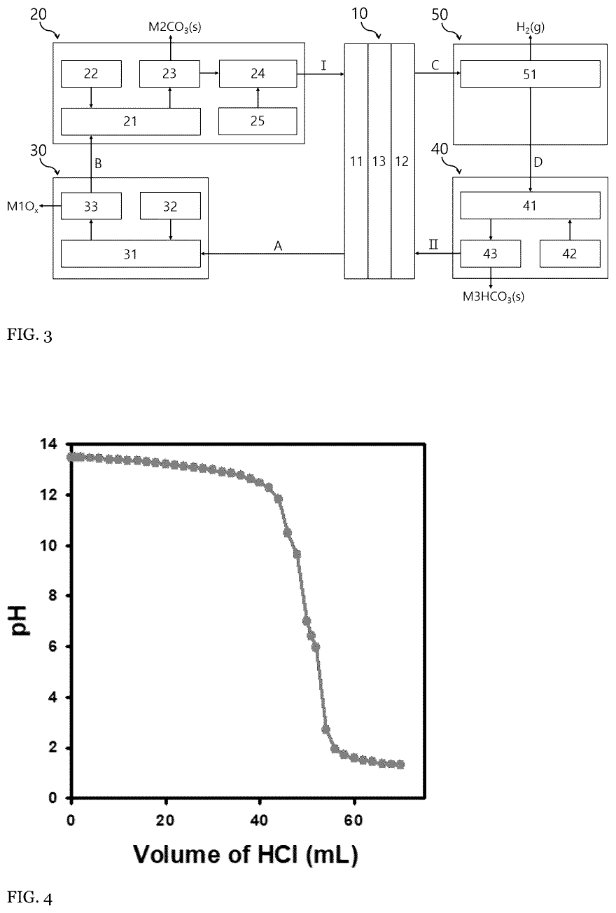

FIG. 2 shows a metal-carbon dioxide battery using the anion exchange membrane 13 as the ion exchange membrane 13, and FIG. 3 shows a metal-carbon dioxide battery using the cation exchange membrane 13 as the ion exchange membrane 13.

Referring to FIGS. 2 and 3, the metal-carbon dioxide battery is described in more detail below. Except for the configurations separately mentioned with reference to FIG. 3, the metal-carbon dioxide battery using the anion exchange membrane 13 and the metal-carbon dioxide battery using the cation exchange membrane 13 are substantially the same, so a redundant description thereof will be omitted.

Referring to FIG. 2, the first electrolyte supply unit 20 may be configured to supply the first electrolyte to the anode 11 through a first connector (not shown) connecting the first electrolyte supply unit 20 and the anode 11. Here, the first connector connects the anode 11 and the first electrolyte supply unit 20, and is configured to allow the first electrolyte, which is a fluid, to flow, and may include a conduit, pipe, or the like.

The first electrolyte may include an alkali metal M3 hydroxide. The alkali metal hydroxide may include any one selected from the group consisting of sodium hydroxide, potassium hydroxide, lithium hydroxide, and combinations thereof. Also, the concentration of the alkali metal hydroxide in the first electrolyte is not particularly limited, but may be 1 M to 7 M, preferably 1 M to 6 M, more preferably 6 M. If the concentration of the alkali metal hydroxide is less than 1 M, the use thereof for a battery may be unsuitable due to limited metal oxidation reaction.

When the first electrolyte is supplied to the anode 11, oxidation reaction at the anode 11 may occur as shown in Schemes 1 and 2 below, forming a first product A.

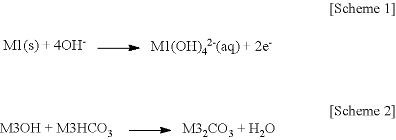

In addition, the metal-carbon dioxide battery according to the present disclosure may further include an oxide precipitation unit 30 located downstream of the anode 11 and configured to separate and recover a first metal oxide. Here, “located downstream of the anode 11” is not limited to the meaning that the oxide precipitation unit 30 is located physically after the anode 11, and may mean a relationship in which the oxide precipitation unit 30 is connected to the anode 11 through a conduit, etc. to thus receive the first product A discharged from the anode 11.

The first product A discharged from the anode 11 may be supplied to the oxide precipitation unit 30. The first product A may be selected from among a first metal hydroxide (M1(OH₄²⁻, M1(OH)³⁻, M1(OH)₂), a first metal oxide (M1Oₓ) (0<x≤3), an alkali metal hydroxide (M3(OH)(aq)), an alkali metal carbonate (M3₂CO₃), and the like.

The oxide precipitation unit 30 may include a first storage tank 31 configured to accommodate the first product A discharged from the anode 11, and a first feeder 32 configured to supply carbon dioxide (CO₂) to the first storage tank 31. In this case, the first product A discharged from the anode may flow through a conduit, pipe, or other configuration (e.g., a first connection) to be supplied to a first storage tank.

When carbon dioxide is supplied to the first storage tank 31, as shown in Schemes 3 to 5 below, the pH of the first product A may be lowered and thus the first metal oxide (M1Oₓ) may be precipitated from the first product A. Here, x may satisfy 0<x≤3.

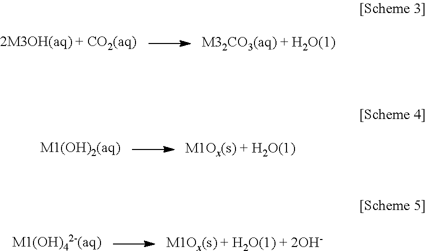

The first feeder 32 may serve to adjust the pH of the first product A contained in the first storage tank 31 to the pH at which the first metal oxide (M1Oₓ) is precipitated as a solid according to the Pourbaix diagram of the first metal oxide (M1Oₓ). For example, the pH of the first electrolyte may be about pH 14 or higher, and the first feeder 32 may be configured to supply carbon dioxide to the first storage tank 31 so that the pH of the first product A is pH 10 to pH 12. If the pH of the first product A exceeds pH 12, the first metal oxide (M1Oₓ) may not be properly precipitated. On the other hand, if the pH of the first product A is less than pH 10, an alkali metal bicarbonate (M3HCO₃) may be unintentionally precipitated from the first product A.

Also, the oxide precipitation unit 30 may further include a first filter 33 located downstream of the first storage tank 31 and configured to separate the first metal oxide (M1Oₓ) precipitated through Schemes 4 and 5 and/or the first metal oxide (M1Oₓ) present in the first product A from the first product A. The first filter 33 may include any filter commonly used in the art to which the present disclosure pertains, so long as it is able to separate the precipitated first metal oxide (M1Oₓ) from the first product A.

The oxide precipitation unit 30 may be configured to supply a second product B, which is obtained by separating the first metal oxide (M1Oₓ) from the first product A, to the first electrolyte supply unit 20 located downstream of the oxide precipitation unit 30. Here, the second product B may include water, alkali metal carbonate (M3₂CO₃), unreacted carbon dioxide, etc. Also, since the alkali metal carbonate (M3₂CO₃) in the second product B is in an aqueous solution state, carbonic anions (CO₃²⁻ and/or HCO₃⁻) may be included. As such, “located downstream of the oxide precipitating unit 30” is based on the direction of flow of the second product B, and the positions of the oxide precipitation unit 30 and the first electrolyte supply unit 20 are not limited to directions such as up, down, left and right.

The first electrolyte supply unit 20 may include a second storage tank 21 configured to accommodate the second product B discharged from the oxide precipitation unit 30, and a second feeder 22 configured to supply a second metal hydroxide (M2(OH)_{y}) to the second storage tank 21. Here, y may satisfy 0<y≤2.

In a conventional anode electrolyte circulation system, the alkali metal carbonate contained in the second product B continues to remain not only in the second product B but also in the first electrolyte, and potassium hydroxide is added to remove the alkali metal carbonate. Even in this case, however, it is difficult to completely remove the alkali metal carbonate, and thus there is a limit to maintaining the concentration of potassium hydroxide with an increase in the number of repetitions of electrolyte circulation. As the concentration of potassium hydroxide in the electrolyte decreases, oxidation reaction of the first metal (e.g., zinc) may be suppressed, deteriorating performance, and also, a film may be formed on the surface of the first metal due to corrosion of the first metal in the alkali solution, which may lead to a decrease in long-term durability of the battery.

Hence, the alkali metal carbonate contained in the second product B has to be removed because performance of the metal-carbon dioxide battery deteriorates and long-term durability decreases when such an alkali metal carbonate continues to remain not only in the second product B but also in the first electrolyte as described above.

The second feeder 22 may be configured to supply the second metal hydroxide (M2(OH)_{y}) to the second storage tank 21 to induce ion exchange reaction of the second product B and the second metal hydroxide (M2(OH)_{y}). More specifically, the alkali metal carbonate in the second product B and the second metal hydroxide (M2(OH)_{y}) may be reacted as shown in Scheme 6 below, precipitating a second metal carbonate (M2CO₃), thereby removing carbonic anions derived from the alkali metal carbonate or aqueous alkali metal carbonate solution from the second product B.

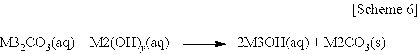

As such, the second metal oxide supplied to the second storage tank may be provided by dissolving the same in water (H₂O) to increase ion exchange reaction efficiency.

In one embodiment, the molar ratio of the alkali metal carbonate in the second product B to the second metal hydroxide (M2(OH)_{y}) supplied by the second feeder 22 may be 1:1 to 1:3.

If the number of moles of the second metal hydroxide (M2(OH)_{y}) relative to the number of moles of the alkali metal carbonate is less than 1:1, the amount of the second metal hydroxide (M2(OH)_{y}) may be too small to completely remove the alkali metal carbonate from the second product B, and thus carbonate ions and/or trace amounts of bicarbonate ions may remain in the first electrolyte. When carbonate ions and/or trace amounts of bicarbonate ions remain in the first electrolyte, the oxidation reaction rate of the first metal (e.g., zinc) may decrease and a film may be formed on the surface of the first metal, deteriorating electrochemical performance and durability of the battery.

On the other hand, if the number of moles of the second metal hydroxide (M2(OH)_{y}) relative to the number of moles of the alkali metal carbonate exceeds 1:3, the second metal ions may remain in the first electrolyte and thus unintended side reaction may occur during oxidation of the first electrolyte at the anode 11.

In one embodiment, the second metal M2 of the second metal hydroxide (M2(OH)_{y}) may include any one selected from the group consisting of calcium (Ca), strontium (Sr), barium (Ba), iron (Fe), lead (Pb), lithium (Li), copper (Cu), and combinations thereof. Preferably, the second metal includes calcium.

The first electrolyte supply unit 20 may further include a second filter 23 configured to separate the second metal carbonate (M2CO₃) precipitated through the process shown in Scheme 6 from the second product B. The second filter 23 may include any filter commonly used in the art to which the present disclosure pertains, so long as it is able to separate the precipitated second metal carbonate (M2CO₃) from the second product B.

As the carbonic anions are removed from the second product B through ion exchange reaction in the first electrolyte supply unit 20, a first electrolyte including an alkali metal hydroxide (aq) may be formed. The first electrolyte supply unit 20 may serve as an electrolyte regeneration system for regenerating the first electrolyte I by precipitating the carbonic anions in the form of carbonate. As such, the first electrolyte according to the present disclosure may be regenerated and circulated through the reaction unit and the first electrolyte supply unit or through the reaction unit, the oxide precipitation unit, and the first electrolyte supply unit.

In one embodiment, precipitation reaction of the second metal carbonate (M2CO₃) may occur at a temperature of 80° C. or less. In this case, the temperature of the first electrolyte supply unit, in particular the temperature of the second storage tank, may be suitably adjusted so that the precipitation reaction of the second metal carbonate occurs at a temperature below 80° C. Accordingly, the role of the system for regenerating the first electrolyte may be faithfully performed in the operating environment of a typical metal-carbon dioxide battery.

In addition, when the cation exchange membrane 13 is used as the ion exchange membrane 13 according to the present disclosure, alkali metal ions may move from the anode 11 to the cathode 12, and hence, continuous operation of the metal-carbon dioxide battery without supplementing the alkali metal ions may result in deteriorated electrochemical performance of the battery.

Referring to FIG. 3, the first electrolyte supply unit 20 may further include a fourth storage tank 24 located downstream of the second filter 23 and configured to accommodate the first electrolyte filtered through the second filter 23, and an electrolyte replenisher 25 connected to the fourth storage tank 24 and configured to replenish the fourth storage tank 24 with an alkali metal hydroxide. Here, the alkali metal hydroxide replenished from the outside by the electrolyte replenisher 25 is preferably the same as the alkali metal hydroxide in the first electrolyte initially supplied to the anode 11.

The first electrolyte supply unit 20 may be configured to supply the first electrolyte, which is regenerated by ion exchange reaction, second metal carbonate (M2CO₃) precipitation reaction, or carbonate ion removal reaction, to the anode 11 through the first connector. The first electrolyte supplied to the anode 11 may receive anions from the cathode 12 or transfer alkali metal ions to the cathode 12, repeating oxidation reaction.

Referring again to FIG. 2, the second electrolyte supply unit 40 may be located upstream of the cathode 12 and configured to supply a second electrolyte including protons, bicarbonate ions, and carbonate ions to the cathode 12. Here, “located upstream of the cathode 12” is not limited to the meaning that the second electrolyte supply unit 40 is located physically before the cathode 12, and may mean a relationship in which the second electrolyte supply unit 40 is connected to the cathode 12 through a conduit, etc. to thus supply the second electrolyte to the cathode 12.

The second electrolyte supply unit 40 may include a third storage tank 41 configured to accommodate the second electrolyte, and a third feeder 42 connected to the third storage tank 41 and configured to supply carbon dioxide to the third storage tank 41. Also, a second connector (not shown) configured to connect the third storage tank 41 and the cathode 12 to supply the second electrolyte to the cathode 12 may be included.

Before operation of the metal-carbon dioxide battery, water (H₂O) may be stored in the third storage tank 41. When carbon dioxide is supplied to the third storage tank 41, dissolution reaction of carbon dioxide may occur as follows, forming a second electrolyte including protons (H⁺) and carbonic anions.

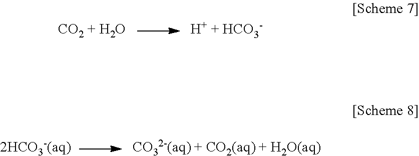

When the second electrolyte is supplied to the cathode 12, hydrogen gas may be generated by reduction reaction as shown in Scheme 9 below.

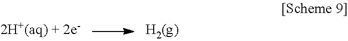

Also, when the ion exchange membrane 13 is an anion exchange membrane 13, the bicarbonate ions (HCO₃⁻) and/or carbonate ions (CO₃²⁻) contained in the second electrolyte may be transferred to the anode 11 through the anion exchange membrane 13.

A third product C formed by reduction reaction at the cathode 12 may be discharged from the cathode 12. The third product C is discharged from the cathode 12 and supplied to the separation unit 50 located at the cathode 12 side. Here, “located at the cathode 12 side” is not limited to the meaning that the separation unit 50 is located near the cathode 12, and may mean a relationship in which the separation unit 50 is connected to the cathode 12 through a conduit, etc. to thus receive the third product C discharged from the cathode 12.

The third product C may include unreacted material D of the second electrolyte, hydrogen gas, etc. The unreacted material D of the second electrolyte may include water, carbon dioxide, protons (H⁺), and carbonic anions. Also, when the ion exchange membrane 13 is a cation exchange membrane 13, the unreacted material D of the second electrolyte may include alkali metal ions transferred from the anode 11 to the cathode 12.

The separation unit 50 may be configured to separate hydrogen gas from the third product C discharged from the cathode 12. For example, the separation unit 50 may include a gas-liquid separator 51 capable of separating and recovering hydrogen gas from the third product C. The type of gas-liquid separator 51 is not particularly limited so long as it is able to separate and recover hydrogen gas from the third product C.

The separation unit 50 may be connected to the second electrolyte supply unit 40. Specifically, the separation unit 50 may be connected to the third storage tank 41 through a conduit, etc. The unreacted material D discharged from the separation unit 50 may be supplied to the second electrolyte supply unit 40 and circulated as a second electrolyte.

Meanwhile, when the ion exchange membrane 13 is a cation exchange membrane 13, the unreacted material D may include alkali metal ions. When the alkali metal ions are not removed from the unreacted material D or the second electrolyte, the difference in alkali metal ion concentration between the anode 11 and the cathode 12 may decrease, deteriorating performance of the metal-carbon dioxide battery.

The alkali metal ions contained in the unreacted material D may be precipitated as an alkali metal bicarbonate (M3HCO₃) by reaction shown in Scheme 10 below.

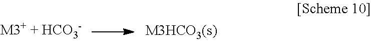

Referring to FIG. 3, the second electrolyte supply unit 40 may further include a third filter 43 located downstream of the third storage tank 41 and configured to separate the alkali metal bicarbonate from the second electrolyte discharged from the third storage tank 41.

Here, “located downstream of the third storage tank 41” is not limited to the meaning that the third filter 43 is located physically after the third storage tank 41, and may mean a relationship in which the third filter 43 is connected to the third storage tank 41 through a conduit, etc. to thus receive the second electrolyte discharged from the third storage tank 41.

Meanwhile, in the present disclosure, the driving force for allowing the first electrolyte and the second electrolyte to flow may be provided by a flow source such as a pump, etc., and in addition thereto, any means that enables flow of the first electrolyte and the second electrolyte and is able to control the flow rates thereof may be used without particular limitation. Also, the flow source may be located at a position suitable for allowing the first electrolyte and the second electrolyte to flow, for example, inside the reaction unit, the first electrolyte supply unit, the oxide precipitation unit, the second electrolyte supply unit, and the separation unit, or therebetween. Also, the number of flow sources may be 1 or more to allow the first electrolyte and the second electrolyte to flow.

Also, Schemes 1 to 10 herein do not necessarily mean that such reactions occur, and it should be understood that such reactions may occur depending on the types of compounds, salts, and ions contained in the electrolyte and the product.

Moreover, the electrolyte regeneration system for a metal-carbon dioxide battery according to the present disclosure may be operated in a continuous flow manner or a batch manner.

A better understanding of the present disclosure may be obtained through the following examples. However, these examples are not to be construed as limiting the technical spirit of the present disclosure.

### EXAMPLE

A metal-carbon dioxide battery as shown in FIG. 3 was constructed. Zinc pellets were used as an anode, and a platinum catalyst supported on a support was used as a cathode. A reaction unit was prepared by interposing a cation exchange membrane (Nafion; DuPont) including a perfluorosulfonic acid-based resin between the anode and the cathode.

An aqueous 6 M potassium hydroxide (KOH) solution was supplied as a first electrolyte to the anode. Also, carbon dioxide was supplied to water contained in a third storage tank, forming a second electrolyte including protons and bicarbonate ions, and the second electrolyte was supplied to the cathode.

The reaction unit was driven to operate the metal-carbon dioxide battery.

A first product discharged from the anode was supplied to a first storage tank. Carbon dioxide was supplied so that the pH of the first product was about pH 11, precipitating zinc oxide (ZnO), and then the zinc oxide was separated using a first filter.

After separation of zinc oxide, a second product was supplied to a second storage tank. An aqueous calcium hydroxide (Ca(OH)₂) solution was supplied to the second storage tank, precipitating carbonate ions in the second product as calcium carbonate (CaCO₃). Then, the calcium carbonate was separated using a second filter. Here, calcium hydroxide was added so that the molar ratio of potassium carbonate (K₂CO₃) in the second product to calcium hydroxide (Ca(OH)₂) supplied by the second feeder was 1:1.

After regeneration of the first electrolyte by removing calcium carbonate from the second product, the first electrolyte was moved to a fourth storage tank, and alkali metal hydroxide was replenished to equal the concentration of alkali metal hydroxide in the initial first electrolyte. For reference, the process of regeneration of the first electrolyte was carried out at room temperature (25° C.) under atmospheric pressure.

Meanwhile, a third product discharged from the cathode was supplied to a gas-liquid separator, separating hydrogen gas from the third product. The remaining unreacted material was moved to the third storage tank of a second electrolyte supply unit. The unreacted material was moved to a third filter connected downstream of the third storage tank, removing an alkali metal bicarbonate formed by reaction of alkali metal ions and bicarbonate in the third storage tank.

Through the above process, the first electrolyte at the anode and the second electrolyte at the cathode were circulated.

### Comparative Example

The same metal-carbon dioxide battery as in Example 1 was constructed, with the exception that the second feeder configured to supply the second metal hydroxide (Ca(OH)₂) to the second storage tank was not provided and no electrolyte regeneration process was actually performed. Then, the first electrolyte at the anode and the second electrolyte at the cathode were circulated.

### Test Example

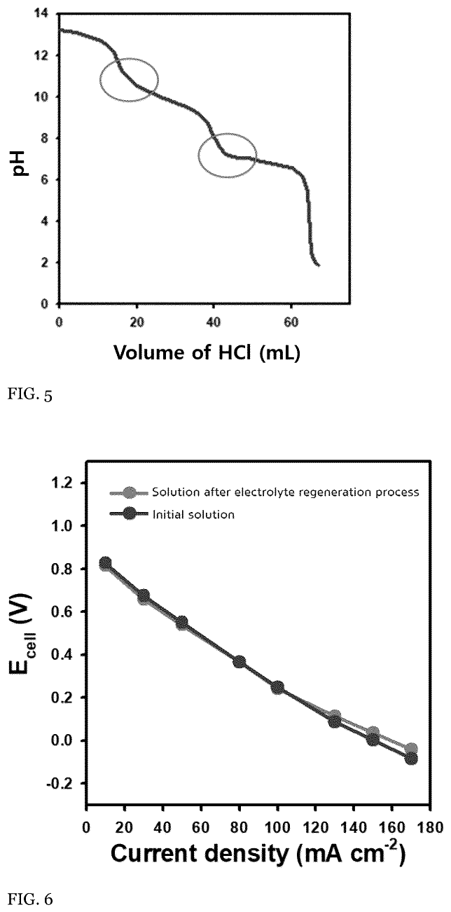

FIG. 4 shows results of hydrochloric acid titration of the first electrolyte regenerated through the second filter during operation of the metal-carbon dioxide battery according to Example, and FIG. 5 shows results of hydrochloric acid titration of the first electrolyte regenerated through the second filter during operation of the metal-carbon dioxide battery according to Comparative Example.

Referring to FIGS. 4 and 5, in FIG. 4 showing the results of hydrochloric acid titration of Example, no inflection point was observed in the pH 10-12 and pH 6-8 ranges, whereas in FIG. 5 showing the results of hydrochloric acid titration of Comparative Example, respective inflection points were observed in the pH 10-12 and pH 6-8 ranges. The reason why two inflection points are observed in FIG. 5 is deemed to be because carbonate ions and bicarbonate ions remain in the first electrolyte, causing a buffer effect during hydrochloric acid titration. Based on the above results, it was confirmed that, in Example using the electrolyte regeneration system, carbonate ions and bicarbonate ions in the second product were appropriately removed by ion exchange reaction with calcium hydroxide and calcium carbonate precipitation.

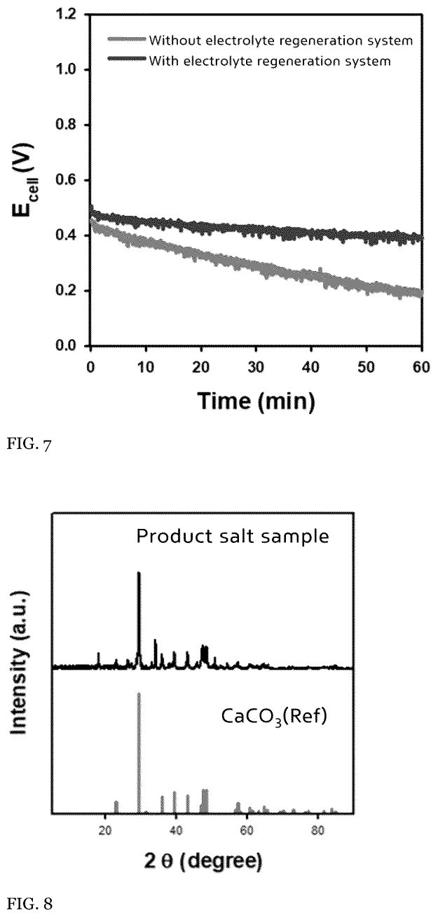

FIG. 6 shows results of comparing the electrochemical performance of the metal-carbon dioxide battery according to Example during first operation at a current density of 50 mA/cm² and the performance thereof after the electrolyte regeneration process. Also, FIG. 7 shows results of comparing changes in battery performance over time during operation of the metal-carbon dioxide battery according to Example and the metal-carbon dioxide battery according to Comparative Example under the same conditions.

As shown in FIG. 6, the performance of the metal-carbon dioxide battery during first operation and the performance of the metal-carbon dioxide battery after regeneration of the first electrolyte through the first electrolyte and second electrolyte circulation processes once were substantially identical, confirming that the metal-carbon dioxide battery including the electrolyte regeneration system according to the present disclosure had excellent electrochemical performance and durability.

Also, according to FIG. 7, in Comparative Example in which the metal-carbon dioxide battery was evaluated by circulating and supplying the first electrolyte (anode electrolyte) without an electrolyte regeneration process, the performance thereof after 1 hour of evaluation was decreased by 53% compared to the initial performance. In contrast, in Example in which the metal-carbon dioxide battery was evaluated by applying the electrolyte regeneration process of separating and precipitating the product from the first electrolyte, the battery performance remained similar even after 1 hour.

FIG. 8 shows results of comparing the XRD peaks of the solid salt recovered through the second filter and the known calcium carbonate.

Referring to FIG. 8, the XRD peak of the known calcium carbonate and the XRD peak of the recovered solid salt were matched with each other, confirming that the recovered solid salt was calcium carbonate. Moreover, the reaction conversion rate was determined to be about 98.5% by weight comparison of the added calcium hydroxide and the produced calcium carbonate, confirming that calcium hydroxide was converted into calcium carbonate.

As is apparent from the above description, according to the present disclosure, a first electrolyte can be regenerated by removing bicarbonate ions and carbonate ions from the electrolyte using a second metal hydroxide such as potassium hydroxide, thereby improving electrochemical performance and durability of a metal-carbon dioxide battery.

Also, additional profits can be generated by precipitating bicarbonate ions and carbonate ions in the electrolyte in the form of second metal carbonate (M2CO₃) such as calcium carbonate and then selling the same.

Furthermore, the metal-carbon dioxide battery according to the present disclosure can be applied to both an anion exchange membrane and a cation exchange membrane, thereby improving electrochemical performance and durability of the battery.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A metal-carbon dioxide battery, comprising:
a reaction unit comprising an anode, a cathode, and an ion exchange membrane located between the anode and the cathode;
a first electrolyte supply unit configured to supply a first electrolyte comprising an alkali metal hydroxide to the anode; and
a second electrolyte supply unit configured to supply a second electrolyte to the cathode,
wherein the first electrolyte supply unit comprises a storage tank which has a space that regenerates the first electrolyte by precipitating carbonic anions in form of carbonate.

2. The metal-carbon dioxide battery of claim 1, wherein the alkali metal hydroxide in the first electrolyte has a concentration range of 1 M to 7 M.

3. The metal-carbon dioxide battery of claim 1, wherein the first electrolyte has a pH of pH 14 or higher.

4. The metal-carbon dioxide battery of claim 1, wherein the alkali metal hydroxide comprises sodium hydroxide, potassium hydroxide, or lithium hydroxide, or combinations thereof.

5. The metal-carbon dioxide battery of claim 1, wherein a first metal of a first metal oxide comprises zinc (Zn), aluminum (Al), or combinations thereof.

6. The metal-carbon dioxide battery of claim 1, further comprising an oxide precipitation unit located downstream of the anode and configured to separate and recover a first metal oxide precipitate.

7. The metal-carbon dioxide battery of claim 6, wherein the oxide precipitation unit comprises:
a first storage tank configured to accommodate a first product discharged from the anode; and
a first feeder configured to supply carbon dioxide to the first storage tank,
wherein the first metal oxide is precipitated from the first product by lowering a pH of the first product as carbon dioxide is supplied to the first storage tank.

8. The metal-carbon dioxide battery of claim 7, wherein the first feeder is configured to supply carbon dioxide to the first storage tank so that the pH of the first product is pH 10 to pH 12.

9. The metal-carbon dioxide battery of claim 7, wherein the oxide precipitation unit further comprises a first filter located downstream of the first storage tank and configured to separate the precipitated first metal oxide from the first product.

10. The metal-carbon dioxide battery of claim 1, wherein the first electrolyte supply unit comprises:
a second storage tank configured to accommodate a second product comprising at least one of carbonate ions or bicarbonate ions; and
a second feeder configured to supply a second metal hydroxide to the second storage tank,
wherein the second product and the second metal hydroxide react in the second storage tank to form a second metal carbonate precipitate.

11. The metal-carbon dioxide battery of claim 10, wherein the first electrolyte supply unit further comprises a second filter configured to separate the precipitated second metal carbonate from the second product.

12. The metal-carbon dioxide battery of claim 11, wherein the first electrolyte supply unit further comprises:
a fourth storage tank located downstream of the second filter and configured to accommodate the first electrolyte filtered through the second filter; and
an electrolyte replenisher connected to the fourth storage tank and configured to replenish the fourth storage tank with an alkali metal hydroxide.

13. The metal-carbon dioxide battery of claim 10, wherein a molar ratio of an alkali metal carbonate in the second product to the second metal hydroxide supplied by the second feeder is 1:1 to 1:3.

14. The metal-carbon dioxide battery of claim 10, wherein precipitation reaction of the second metal carbonate occurs at a temperature of 80° C. or less.

15. The metal-carbon dioxide battery of claim 1, wherein the ion exchange membrane comprises an anion exchange membrane, and the anion exchange membrane comprises material that is capable of transfer of carbonic anions, which are contained in the second electrolyte supplied to the cathode, to the anode.

16. The metal-carbon dioxide battery of claim 1, wherein the ion exchange membrane comprises a cation exchange membrane, and the cation exchange membrane comprises material that is capable of transfer of alkali metal ions contained in the first electrolyte to the cathode.

17. The metal-carbon dioxide battery of claim 1, further comprising a separation unit located at a cathode side and configured to separate hydrogen gas from a third product discharged from the cathode.

18. The metal-carbon dioxide battery of claim 17, wherein the separation unit is connected to the second electrolyte supply unit, and an unreacted material discharged from the separation unit is supplied to the second electrolyte supply unit.

19. The metal-carbon dioxide battery of claim 17, wherein the second electrolyte supply unit comprises:
a third storage tank configured to accommodate the second electrolyte; and
a third feeder connected to the third storage tank and configured to supply carbon dioxide to the third storage tank,
wherein a second electrolyte comprising protons and carbonic anions is formed by reaction of water and carbon dioxide in the third storage tank.

20. The metal-carbon dioxide battery of claim 19, wherein the second electrolyte supply unit further comprises a third filter located downstream of the third storage tank and configured to separate an alkali metal bicarbonate from the second electrolyte discharged from the third storage tank.
